(19) United States
(12) Patent Application Publication
(10) Pub. No.: US 2007/0176670 A1
(43) Pub. Date: Aug. 2, 2007

(54) Charge pump based subsystem for secure smart-card design

(76) Inventors: Pasquale Corsonello, Cosenza (IT); Martin Margala, Pittsford, NY (US); Stefania Perri, Cosenza (IT)

Correspondence Address: BLANK ROME LLP, 600 NEW HAMPSHIRE AVENUE, N.W., WASHINGTON, DC, 20037, US

(21) Appl. No.: 11/331,362

(22) Filed: Jan. 13, 2006

Related U.S. Application Data
(60) Provisional application No. 60/643,165, filed on Jan. 13, 2005.

(51) Int. Cl. G05F 1/10

(52) U.S. Cl. 327/536

(57) ABSTRACT

A smart card includes a power source, a processing chip, and a charge-pump subsystem for powering the processing chip. The charge-pump subsystem includes a capacitor which is connected cyclically to the power source to charge the capacitor, to the processing chip to power the processing chip, and to ground to discharge the capacitor. The charge-pump subsystem can include three such capacitors so that while one of them is charging, another is powering the processing chip, and a third is discharging. The charge-pump subsystem blocks attempts to discover a secret key in the processing chip by decorrelating power consumption from the internal operations of the processing device.

### REFERENCE TO RELATED APPLICATION

The present application claims the benefit of U.S. Provisional Patent Application No. 60/643,165, filed Jan. 13, 2005, whose disclosure is hereby incorporated by reference in its entirety into the present disclosure.

### FIELD OF THE INVENTION

The present invention is directed to a power source for smart cards and more particularly to such a power source which provides a countermeasure against non-invasive attacks such as power analysis.

### DESCRIPTION OF RELATED ART

Smart cards provide portable containers for account, public key, and biometric data. They are increasingly prevalent for payment mechanisms (e.g., mobile telephone SIMs and credit cards). They are also used as storage of medical information, as a personal identification card and as a means of a computer access control. The cards, containing a microprocessor and memory, cost in the range of US$2 to 10. The technology is deployed in over 90 countries, mostly in Europe and Asia, with over a billion cards shipped annually.

The first application was prepaid telephone cards in Europe in the mid-1980s. The worldwide GSM mobile phone network is now secured by more than 500 million smart cards. On many cellular telephone networks, a subscriber uses a SIM (Subscriber Identity Module) smart card to activate the telephone. The card authenticates the user and provides encryption keys for digital voice transmission. SIM cards can also provide transactional services such as remote banking, cash machines, bill paying, and bridge tolls.

In France, 40 million banking cards have been deployed, and in Germany, 80 million health cards have been issued. Use in the United States has been slower because of an existing investment in infrastructure for the older magnetic stripe cards, but applications are being developed for smart cards in financial transactions, medical records, driver licenses and ID cards, wherever security and authenticated identity are important, such as in controlling access to secure facilities and to medical records.

The market research firm of Frost & Sullivan predicts a 27% compound annual growth rate through 2010 for smart cards in North America. The largest market segment in 2005 was SIM cards for wireless telephones, followed by payments, pay TV, government issued identification and access control. The deployment of the U.S. e-passport will be a key growth factor in that market. Enterprise access control applications are leading to smart-card-based ID badges that combine physical and logical access.

Increasing concern over security demands protection against attackers who attempt to gain unlawful access to the above services through invasive or non-invasive attacks. Non-invasive attacks (also named side channel attacks or passive attacks) are more subtle because they do not leave evidence of tampering.

The most powerful side channel attack is the power analysis (PA). It allows secret keys to be extracted from differences among data dependent power consumption levels. This kind of attack is based upon examination of the power consumed by the system during data elaborations. The relationship between the variation in power consumption and elaborated data enables an attacker to discover secure information.

A more detailed description of PA will now be given with reference to FIG. 12. A smart card receives plaintext input 1202 and applies it to a cryptographic algorithm 1204. The cryptographic algorithm 1204 encrypts the plaintext input 1202 with a secret key 1206 to output ciphertext output 1208. An intruder desiring to extract the secret key 1206 non-invasively can observe the power dissipation, timing information and faulty outputs, collectively designated 1210, to derive information leaks 1212 about the secret key.

To make PA ineffective, power consumption has to be data independent. Various protective approaches have been proposed in both the software level and the hardware level. One hardware countermeasure is based on the introduction of random timing shifts and noises, so that computations derived from power consumption do not correspond to a specific data. However, random noise could be eliminated by averaging multiple power consumption curves.

Several previous proposals deal with the use of differential logic styles, such as Current Mode Logic (CML) and Sense Amplifier Based Logic (SABL). These styles significantly increase power, sometimes reduce logic swing and act as efficient countermeasures only if loads on differential branches are equal and internal node capacitances of the gates contribute equally to power dissipation in each transition. These conditions are very hard to obtain and at best require a very long time for producing custom layouts.

Also, the asynchronous design style is being investigated as PA countermeasure. The main drawback of this approach is that the design of the secured circuit has to be completely modified.

All of the above approaches lead to much higher design complexity with respect to conventional logic design styles and do not allow realizing circuits that are completely immune to power attacks, since even a small nonuniformity in the power consumption curve can be captured and analyzed and could lead to disclosure of secure information.

The possibility of using capacitors as isolation elements between the power supply and the smart card chip has been proposed. Two switched capacitors alternatively supply the chip for a quite long time (e.g. tens of microseconds). An example is taught in U.S. Pat. No. 6,507,913 B1 to Shamir.

The size of the above capacitors is on the order of μF. Thus, the capacitors require a very large area and cannot be integrated into the chip, but instead have to be placed in a cavity of the plastic card. For this reason, wires connecting capacitors to the smart card chip can be easily intercepted, thus nullifying the protection.

A contactless smart-card ASIC has been proposed, using a voltage regulator as an isolation circuit in order to prevent bit error rate. Such a circuit provides 66 dB of isolation. However, it requires large by-pass capacitors, and the parasitic effects of the pass transistor used in the regulator limits the extent of the protection. Also, it has not been demonstrated that high-frequency switching components can be filtered with such simple action.

### SUMMARY OF THE INVENTION

It will be seen from the above that a need exists in the art for improved protection against non-invasive attacks such as power attacks.

It is therefore an object of the invention to provide a new protective technique against power attacks.

It is another object of the invention to provide such a technique which does not modify the physical design of the secured circuit.

It is another object of the invention to provide such a technique which can be easily applied at a block level

It is another object of the invention to provide such a technique which allows data independent power consumption to be obtained for any logic design style.

It is another object of the invention to provide such a technique which can be easily integrated into the smartcard chip without introducing significant silicon area overheads.

To achieve the above and other objects, the present invention exploits a three-phase charge-pump based circuit that avoids direct connections between the supply voltage source and the secure block. In this way, high security is reached, but at some power and delay expense. However, smart card applications are not time critical, and energy dissipation is typically not a major concern, since power is attained from card readers.

The present invention exploits a simple charge-pump based circuit which replicates a given input voltage Vdd. PA countermeasures based on charge-pump action were not presented before.

The switching rate of the charge pump should preferably be higher than the switching rate of the logic circuit to be protected, to assure good noise margins with the small integrated capacitors to be used. In one embodiment, three charge pumps are used, so that while one charge pump is charging, a second is powering the logic circuit, and a third is discharging. In such an embodiment, at least three charge pumping actions take place during a switching period of the logic circuit.

The present invention provides a hardware technique for the realization of secure Smart-Cards and provides a valid countermeasure against non-invasive attacks, such as power analysis. It is based on a simple subcircuit that can be easily integrated into the smart card chip. It has been proved that the new technique decorrelates the power consumed by any digital circuit from the internally elaborated data, thus avoiding extraction of secret information from smart cards during the execution of their internal computations.

The present invention has demonstrated significant effectiveness in providing greater data security compared to previously reported hardware methods. In the present invention, an additional charge-pump based subsystem is used to nullify the signature of the switching activity of a CMOS circuit on the supply current. The present invention has been successfully applied to protect cryptographic hardware portion of smart cards.

### BRIEF DESCRIPTION OF THE DRAWINGS

A preferred embodiment of the present invention and variations thereon will be set forth in detail with reference to the drawings, in which:

FIG. 1 is a block diagram showing the use of the charge-pump circuit in the preferred embodiment;

FIG. 2 is a circuit diagram of an only NMOS implementation of the charge-pump circuit of FIG. 1;

FIG. 3 is a timing diagram of the control signals of the charge-pump circuit of FIG. 2;

FIG. 4 is a circuit diagram of an NMOS-PMOS implementation of the charge-pump circuit of FIG. 1;

FIG. 5 is a block diagram of a DES core using the charge-pump circuit of FIG. 4;

FIG. 6 is a plot of post-layout simulations of the DES core of FIG. 5;

FIG. 7 is a plot of the Start signal, the DES clock signal and the ninth bit of the cypper-text obtained from the DES core of FIG. 5;

FIG. 8 is a microphotograph of a chip implementing the DES core of FIG. 5;

FIG. 9 is a plot of Clk_cps and current absorbed by the CPSs measured on the fabricated chip of FIG. 8;

FIG. 10 is a plot of the ninth bit of the cipher-text and the Start signal measured on the fabricated chip of FIG. 8;

FIG. 11 is a plot of the sixty-fourth bit of the cipher-text and Start signal measured on the fabricated chip; and

FIG. 12 is a flow chart showing a non-invasive attack on a smart card by power analysis, as understood in the prior art.

### DETAILED DESCRIPTION OF THE PREFERRED EMBODIMENTS

A preferred embodiment of the present invention and modifications thereof will be set forth in detail with reference to the drawings, in which like reference numerals refer to like elements or steps throughout.

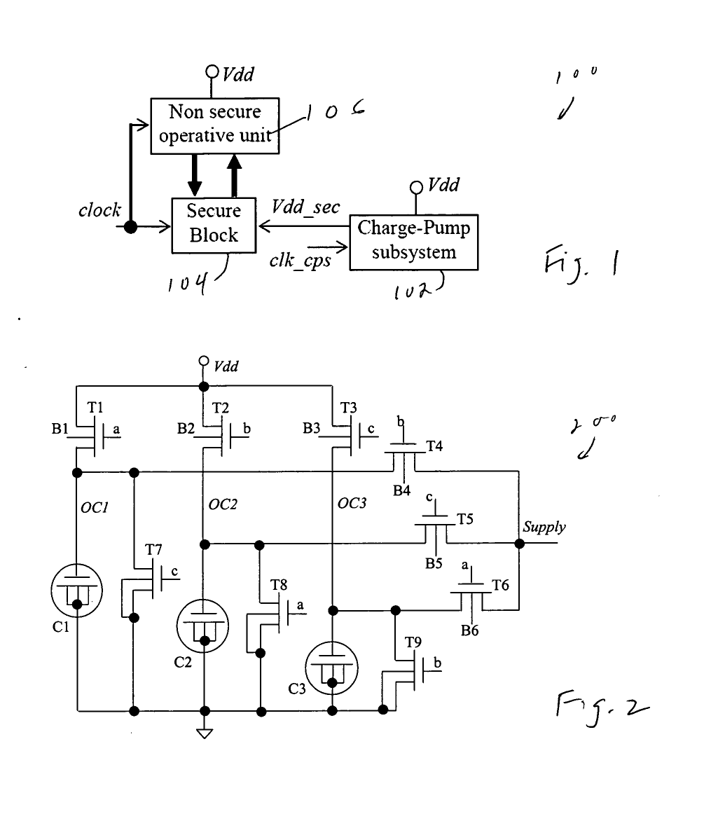

FIG. 1 shows a block diagram of a smart-card circuit 100 according to the preferred embodiment. In the circuit 100, a charge-pump subsystem 102 is powered by a voltage Vdd and in turn powers the digital secure block 104. A non-secure operative unit 106, which can include anything that does not have to be protected from PA, can be powered separately by the voltage Vdd.

From its power supply side, the digital block 104 to be secured (e.g. realized using conventional CMOS standard cells) can be easily seen as a capacitor that corresponds to the parallel of all load and parasitic capacitors in the block that can be charged at the same time.

The preferred embodiment exploits a particular three-phase charge-pump based subsystem (CPS) 102 that receives the clock signals clk_cps and powers one or more secure blocks in which secret data are managed. Charge-pump capacitors (Cpump) and their switching frequency (fclk_cps) should be chosen to accommodate the desired circuit performance and signals rise-time. The switching frequency of the charge-pump capacitors is higher than that of the secure blocks to assure a good noise margin.

The CPS can easily be integrated in the main chip without using external components and without modifying the logic circuitry to be secured. As noted above, every other portion of the chip which does not contain or use secret data can be supplied by the conventional power system.

One implementation of the CPS 102 of FIG. 1, using twelve NMOS transistors, is shown in FIG. 2 as 200. The bulk nodes Bi of transistors Ti (with i=1 , . . . , 6) do not have specific connections. Those bulk nodes are preferably grounded, although other configurations are possible. In one such alternative configuration, the bulk nodes B1, B2 and B3 are connected to OC1, OC2 and OC3, respectively, whereas the bulk nodes B4, B5 and B6 are connected to the supply node, since it can never reach a voltage value higher than OC1, OC2 and OC3.

The circled transistors operate as the pump capacitors (C1, C2 and C3) that alternately pump charge to the secure circuit through the transistors T4, T5 and T6, respectively. The behavior of the pump capacitors is defined in a cyclic three-phase sequence through the control signals a, b, and c. The latter are generated by a simple switch control unit and allow the main three phases to occur as specified below: during the first phase (i.e. a=0, b=1, c=0), the transistors T1, T3, T5, T6, T7 and T8 are turned off, whereas the transistors T2, T4 and T9 are turned on. Therefore, C1 powers the secure block (it is assumed that C1 was previously charged), C2 is charging, whereas C3 is discharging. During the second phase (i.e. a=0, b=0, c=1), the transistors T1, T2, T4, T6, T8 and T9 are turned off, whereas the transistors T3, T5 and T7 are turned on. In this case, C1 is discharging, C2 acts as pump and C3 is charging. Finally, during the third phase (i.e. a=1, b=0, c=0), the transistors T2, T3, T4, T5, T7 and T9 are turned off, whereas the transistors T1, T6 and T8 are turned on.

The above running guarantees that the supply line is periodically connected to a freshly charged capacitor, acting as a charge-pump, instead of the external supply source.

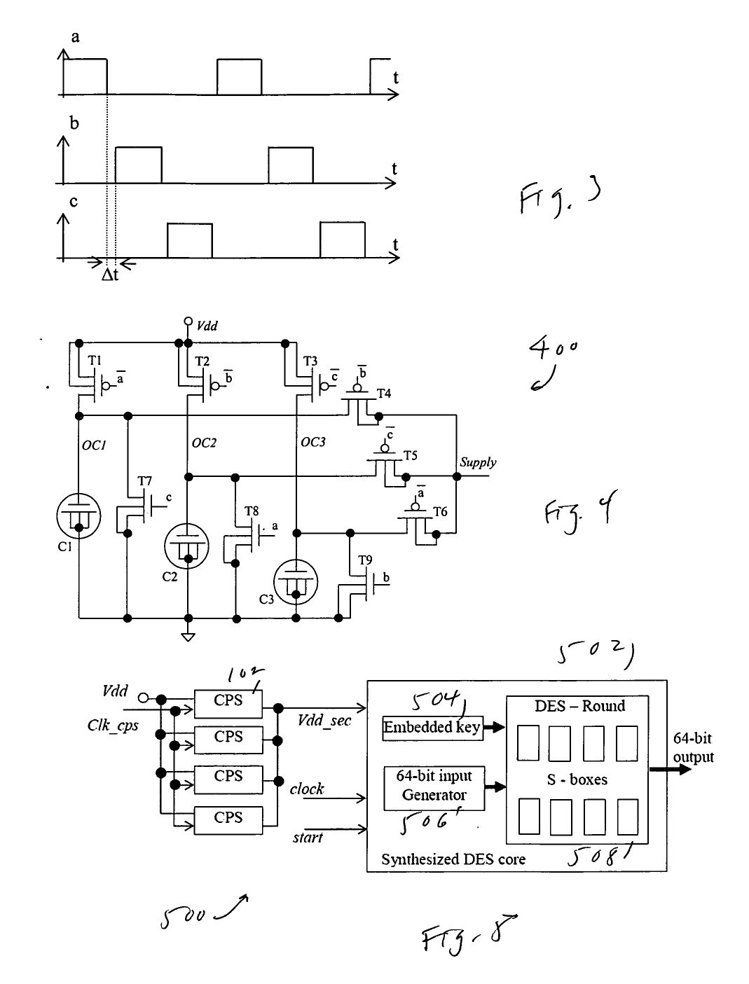

In order to ensure that the CPS runs correctly, the high logic levels on the control signals a, b and c cannot overlap each other. That is, their timing waveforms have to appear as shown in FIG. 3. The time At elapses between any two consecutive phases of the cyclic sequence defined above. During this short time, the supply voltage of the secure block is maintained by the intrinsic capacitance of the supply line. The three phases occur at least once during a single clock cycle of the secure block.

In still another variation, some of the NMOS transistors are replaced with PMOS transistors, as in the CPS 400 of FIG. 4. However, when security is more important than speed, it is preferred to use the CPS 200 of FIG. 2 with the bulk nodes grounded.

Experimental results will now be provided.

Most often, smart cards are fabricated using mature CMOS processes (e.g. 0.6 μm, 0.35 μm), and they run at relatively low clock frequencies (e.g. 5-10 MHz). The embodiment for which the experimental results are provided uses the AustriaMikroSystems (AMS) 0.35 μm 4-metal 2-poly 3.3V CMOS technology.

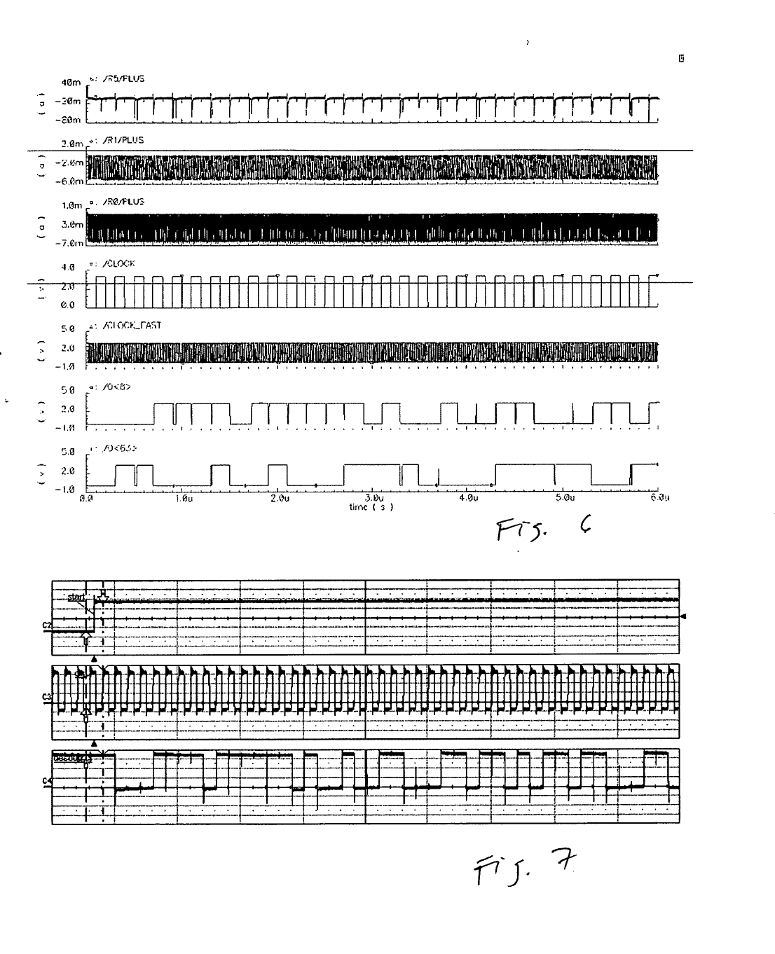

The preferred embodiment has been applied to protect a typical complex digital module used inside Smart-card ICs. For this purpose, a hardware DES encryption core has been synthesized. It performs a complete encryption in 17 clock cycles. The circuit has been realized using the AMS 0.35 μm CMOS Standard Cells and is protected by four CPSs. More specifically, as shown in FIG. 5, the circuit 500 includes a DES encryption core 502 supplied with power by four CPSs 102. The DES core 502 supplies an embedded key 504 and an input from a 64-bit input generator 506 to DES-round and S-boxes 508 to produce a 64-bit output. The synthesized DES core has been also analyzed by means of Synopsys tools that allowed internal capacitive effects and their distribution to be evaluated. Then, the Cpump value has been chosen as a fraction of the total internal capacitance, and a proper value for fckl_cps has been fixed to accommodate the desired circuit performance and signals rise-time.

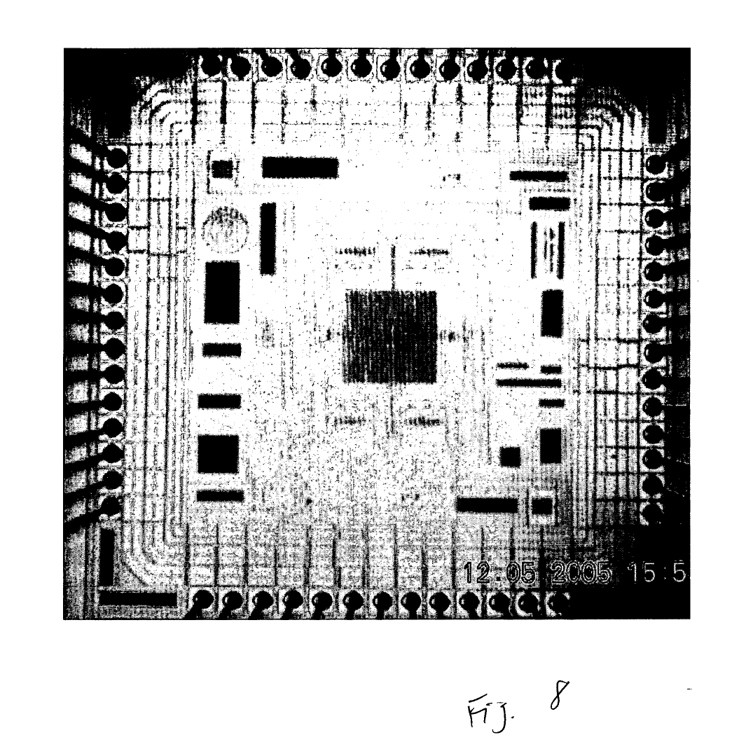

In FIG. 7, chip level post-layout simulation results of the DES core protected by CPSs are reported. The waveforms of FIG. 7 represent from the top to the bottom: the current in the I/O PADs supply voltage, the current supplying the CPS, the current supplying the auxiliary control signal of the CPS, the clock signal of the DES encryption core, the clock signal received by the CPSs, and the ninth and sixty-fourth bits of cipher-text. It should be noted that the output signals have been left intentionally unregistered to observe the effect of the supply system on the glitches. The output waveforms reported in FIG. 6 include the regeneration action of output pads conventionally powered at 3.3V. As a result, the step-by-step rising of the output signals due to the charge-pump effect is not visible.

To verify that the new power supplying method allows the correct operation of the protected system, a reference hardware design of the DES encryption core without any additional circuitry has been implemented on a Xilinx XC2V1000 FPGA chip. FIG. 7 illustrates the Start signal that initiates the encryption phase, the DES clock signal and the ninth bit of the cipher-text. From comparing the waveforms of FIGS. 6 and 7, the correct operation of the simulated ASIC design can be observed.

The chip microphotograph is shown in FIG. 8. The DES encryption module which is in the center of the die is clearly visible. Along the top and bottom sides of the DES encryption module, the four CPSs have been placed. Each one uses three 1pF capacitors and occupies 180 μm×70 μm. Their auxiliary control circuit requires 180 μm×40 μm of silicon area. A simple programmable ring oscillator has been used to generate the Clk_cps signal. It allows 43MHz, 71MHz and 188MHz clocks to be generated.

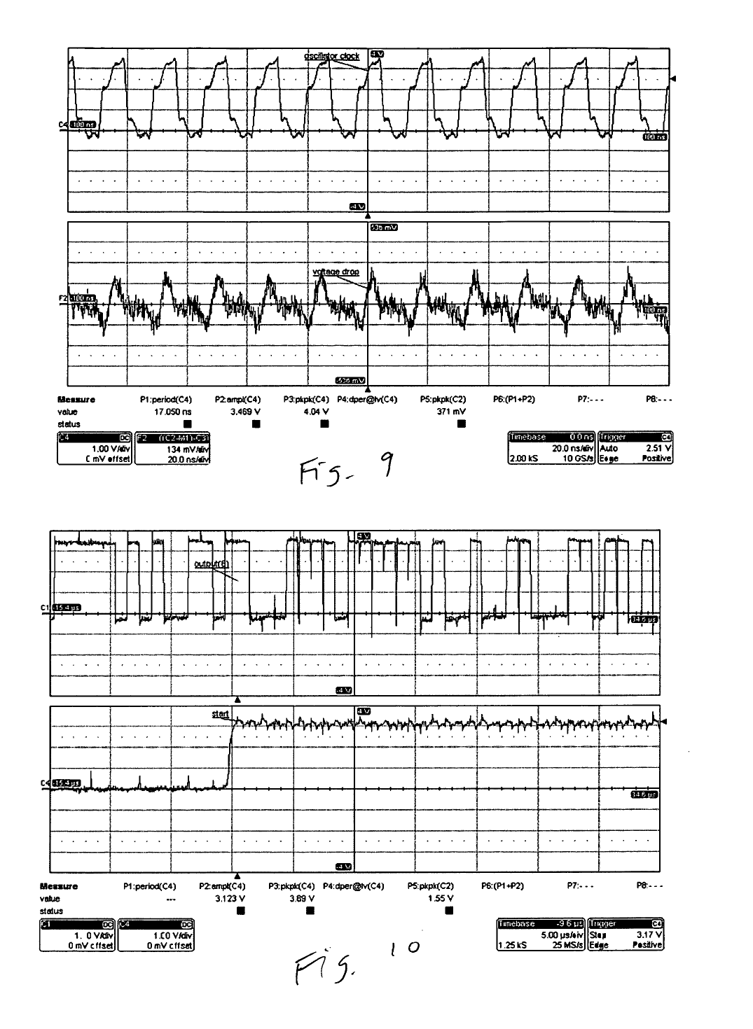

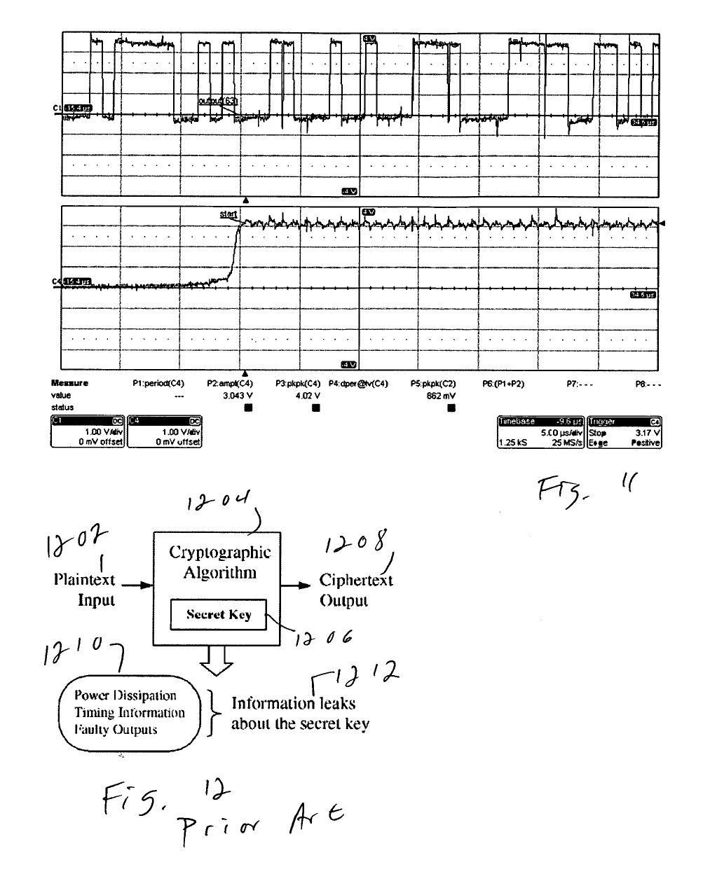

The oscilloscope screen-shot of FIG. 9 reports the Clk-cps signal and the current absorbed by the protected system during the normal encoding running. It can be observed that each clock cycle corresponds to a charge-pump current pulse which does not carry any signature of the encoding computation. The oscilloscope screen-shots of FIGS. 10 and 11 illustrate the ninth and sixty-fourth bits of the cipher-text together with the Start signal. Comparison with FIGS. 6 and 7 demonstrates the correct running of the DES core.

For test purposes only, separate supply voltages have been used for the CPSs and for the I/O PADs. In fact, the current supplying the I/Q PADs is directly depending on the PADs switching activity (i.e. on the outgoing cipher-texts) and it is unrelated to the DES module activity, as visible in the first waveform of FIG. 6. This does not constitute a leakage of secret information, since the cipher-texts are usually sent through the transmission channel, thus they are intrinsically externally observable.

The fabricated prototype demonstrated four main innovations, with respect to previous attempts to use capacitors as isolation elements in Smart-Card designs:
Small capacitors can be used to supply the digital core to be protected exploiting the charge-pump effect;
Such additional sub-systems can be easily distributed inside the chip to supply independent portions of the entire circuit;
Even though the capacitors used are smaller than those used in the prior art, the global performance of the protected circuit is maintained;
Such small capacitors can be easily integrated into the Smart-Card chip without significantly increasing the silicon area.

Furthermore, as a side effect of the integration, information leakage from electromagnetic (EM) emanations is highly reduced. This is mainly because the circuit to be secured is not directly supplied by means of any periphery PAD. EM emanations are mostly caused by the current flowing in large devices and in their large connection rings. Using the preferred embodiment, the only relevant current flowing through the periphery cells is that shown in FIG. 9. Therefore, the EM emanations are mainly constituted by such signal which is unrelated with DES activity. For this reason, the preferred embodiment is also less vulnerable to EM attacks, with respect to known techniques.

While a preferred embodiment of the invention has been set forth in detail above, those skilled in the art who have reviewed the present disclosure will readily appreciate that other embodiments can be realized within the scope of the invention. For example, numerical values are illustrative rather than limiting, as are recitations of fabrication technologies. Therefore, the present invention should be construed as limited only by the appended claims.

We claim:

1. A charge-pump subsystem for powering a processing device from a power source, the charge-pump subsystem comprising:
a charge pump capacitor for being charged by the power source and pumping charge into the processing device; and
a switch for connecting the charge pump capacitor in a first phase to the power source to charge the capacitor, in a second phase to the processing device to power the processing device, and in a third phase to ground to discharge the charge pump capacitor, such that no two of the first, second and third phases overlap in time;
wherein a switching rate of the switch is higher than a clock speed of the processing device.

2. The charge-pump subsystem of claim 1, wherein the capacitor and the switch comprise transistors.

3. The charge-pump subsystem of claim 2, wherein the transistors are NMOS transistors.

4. The charge-pump subsystem of claim 1, comprising a plurality of said capacitors and a plurality of said switches, each of said capacitors being connected between the power source and the processing device by one of said switches.

5. The charge-pump subsystem of claim 4, comprising at least three of said capacitors and at least three of said switches, wherein, during a single clock cycle of the processing device, each of said capacitors goes through said first, second and third phases.

6. The charge-pump subsystem of claim 1, wherein the charge-pump subsystem and the processing device are formed on a single integrated-circuit chip.

7. A method for powering a processing device from a power source by using a charge pump subsystem which comprises a charge pump capacitor, the method comprising:
(a) connecting the power source to the charge pump capacitor to charge the capacitor;
(b) connecting the charge pump capacitor to the processing device to power the processing device; and
(c) connecting the charge pump capacitor to ground to discharge the capacitor;
wherein no two of steps (a), (b) and (c) overlap in time, and wherein steps (a), (b) and (c) are performed within a single clock cycle of the processing device.

8. The method of claim 7, wherein steps (a), (b) and (c) are performed cyclically.

9. The method of claim 8, wherein a plurality of said charge pump capacitors are used, and wherein at any time, no two of said charge pump capacitors are in any one of steps (a), (b) and (c).

10. The method of claim 9, wherein at least three of said charge pump capacitors are used, and wherein, when a first one of said capacitors is in step (a), a second one of said capacitors is in step (b) and a third one of said capacitors is in step (c), and wherein, during a single clock cycle of the processing device, each of said capacitors goes through said first, second and third phases.

11. The method of claim 7, wherein the processing device is provided in a smart card.

12. A processing system comprising:
a power source;
a processing device; and
a charge-pump subsystem for powering the processing device from the power source, the charge-pump subsystem comprising:
a charge pump capacitor; and
a switch for connecting the charge pump capacitor in a first phase to the power source to charge the charge pump capacitor, in a second phase to the processing device to power the processing device, and in a third phase to ground to discharge the charge pump capacitor, such that no two of the first, second and third phases overlap in time, wherein a switching rate of the switch is higher than a clock speed of the processing device.

13. The processing system of claim 12, wherein the capacitor and the switch comprise transistors.

14. The processing system of claim 13, wherein the transistors are NMOS transistors.

15. The processing system of claim 12, wherein the charge-pump subsystem comprises a plurality of said capacitors and a plurality of said switches, each of said capacitors being connected between the power source and the processing device by one of said switches.

16. The processing system of claim 15, wherein the charge-pump subsystem comprises at least three of said capacitors and at least three of said switches.

17. The processing system of claim 16, wherein, when a first one of the capacitors is in the first phase, a second one of the capacitors is in the second phase and a third one of the capacitors is in the third phase), and wherein, during a single clock cycle of the processing device, each of said capacitors goes through said first, second and third phases.

18. The processing system of claim 12, wherein the charge-pump subsystem and the processing device are formed on a single integrated-circuit chip.

19. The processing system of claim 18, wherein the processing system is configured as a smart card.

20. The processing system of claim 12, wherein the processing system is configured as a smart card.

21. The processing system of claim 12, further comprising additional operational components which are powered by the power source while bypassing the charge-pump subsystem.

22. A smart card comprising:
a power source
a processing device; and
a charge pump subsystem for powering the processing device from the power source;
wherein the power source, the processing device and the charge pump subsystem are integrated into the smart card, and wherein a switching rate of the charge pump subsystem is higher than a clock speed of the processing device.

23. The smart card of claim 22, wherein the processing device and the charge pump subsystem are formed on a single integrated circuit chip.

24. The smart card of claim 22, further comprising additional operational components which are powered by the power source while bypassing the charge-pump subsystem.
